(19) United States
(12) Patent Application Publication
(10) Pub. No.: US 2026/0210462 A1
(43) Pub. Date: Jul. 23, 2026

(54) BELL CONNECTIONS

(71) Applicant: ADVANCED DRAINAGE SYSTEMS, INC., Hilliard, OH (US)

(72) Inventors: Nathan MUSTO, Columbus, OH (US); Joshua CISLO, Findlay, OH (US)

(73) Assignee: ADVANCED DRAINAGE SYSTEMS, INC., Hilliard, OH (US)

(21) Appl. No.: 19/385,235

(22) Filed: Nov. 11, 2025

Related U.S. Application Data
(60) Provisional application No. 63/719,179, filed on Nov. 12, 2024.

(51) Int. Cl. F16L 21/06

(52) U.S. Cl. CPC F16L 21/06

(57) ABSTRACT

The disclosed embodiments describe systems, methods, and devices for a fitting. These systems, methods, and devices may include a fitting, which may comprise a hollow body, and a bell portion extending from the body, wherein the bell portion may comprise a clamshell opening, and at least one cleat extending from an internal surface of the bell portion.

### CROSS-REFERENCE TO RELATED APPLICATIONS

This application claims the benefit of priority of U.S. Provisional Application No. 63/719,179, filed Nov. 12, 2024, the contents of which are incorporated herein by reference in their entirety.

### TECHNICAL FIELD

This disclosure relates generally to systems, methods, and devices for providing improved bell and spigot connections, and more particularly, to providing improved bell and spigot connections by using bell connections that may engage a variety of diameters of pipes.

### BACKGROUND

Bell and spigot connections may be used to connect two or more pipes or fittings together. A first pipe may include a “bell” end, which may include an expanded diameter at the end of the pipe. A second pipe may include a plain end pipe segment that may be referred to as a “spigot.” When connecting the two pipes or fittings together, the spigot end of the second pipe may be inserted into the bell end of the first pipe. Bell and spigot connections may provide a tight and secure connection between two or more pipes or fittings to maintain strength and hydraulic flow through the pipes or fittings. Bell and spigot connections may allow for easy installation and disassembly of pipe systems, which may facilitate easier installation, maintenance, and repairs. Current techniques for bell ends of pipes may include bell ends with fixed outer diameters. Such fixed outer diameters prevent the bell end of the pipe from connecting to a wider range of pipe dimensions. For example, the fixed outer diameters of the bell end of the pipe may allow the bell end of the pipe to connect to only a small range of diameters, which limits the functionality of the bell end.

Solutions are needed to improve these and other deficiencies in bell and spigot connections. Such solutions should create a secure connection between the bell end of a first pipe or fitting and the spigot portion of a second pipe or fitting. Such solutions should also provide bell ends of a first pipe or fitting that may be used to connect to a variety of diameters of second pipes or fittings. Such solutions should be designed for easy installation and removal of the spigot end of a second pipe or fitting into the bell end of the first pipe or fitting.

### SUMMARY

The disclosed embodiments describe systems, methods, and devices for a fitting. These systems, methods, and devices may include a fitting, which may comprise a hollow body, and a bell portion extending from the body, wherein the bell portion may comprise a clamshell opening, and at least one cleat extending from an internal surface of the bell portion. In some embodiments, the clamshell opening may comprise a living hinge configured to open and close the clamshell opening. In some embodiments, the clamshell opening may be configured to open a portion of the bell portion to connect a pipe to the bell portion. In some embodiments, the clamshell opening may comprise a ratcheting hinge configured to lock the clamshell opening in an open position. In some embodiments, a diameter of the bell portion may be greater than a diameter of the body of the fitting. In some embodiments, the clamshell opening may extend around half a circumference of the end.

The disclosed embodiments also describe alternative systems, methods, and devices for a fitting. These alternative systems, methods, and devices may include a fitting which may comprise a hollow body, and an end extending from the body, wherein the end may comprise an internal bell portion comprising at least one cleat extending from an internal surface of the end, and a plurality of internal spigot portions comprising a spigot surface raised above the internal surface of the end by legs. In some embodiments, the internal bell portion may be configured to engage a pipe with an outer diameter that corresponds to an inner diameter of the end. In some embodiments, the internal spigot portion may be configured to engage a pipe with an inner diameter that corresponds to an outer diameter of the internal spigot portion. In some embodiments, the at least one cleat may comprise four cleats. In some embodiments, the at least one cleat may be spaced equidistantly around an inner circumference of the end. In some embodiments, the plurality of internal spigot portions may comprise four internal spigot portions. In some embodiments, the plurality of internal spigot portions may be spaced equidistantly around an inner circumference of the end. In some embodiments, the internal bell portion may be made from a same material as the internal spigot portion. In some embodiments, the internal bell portion may be made from a different material than the internal spigot portion.

The disclosed embodiments also describe other systems, methods, and devices for a fitting. These other systems, methods, and devices may include a fitting which may comprise a hollow body, a small bell portion comprising at least one cleat extending upwardly from an internal surface of the small bell portion, and a large bell portion comprising at least one cleat extending upwardly from an internal surface of the large bell portion, wherein the small bell portion may be located between the hollow body and the large bell portion. In some embodiments, a diameter of the small bell portion may be greater than a diameter of the hollow body and the diameter of the small bell portion may be less than a diameter of the large bell portion. In some embodiments, a diameter of the large bell portion may be larger than a diameter of the hollow body and a diameter of the small bell portion. In some embodiments, the large bell portion and the small bell portion may be oriented concentrically. In some embodiments, the large bell portion and the small bell portion may be oriented eccentrically.

Additional features and advantages of the disclosed embodiments will be set forth in part in the description that follows, and in part will be obvious from the description, or may be learned by practice of the disclosed embodiments. The features and advantages of the disclosed embodiments will be realized and attained by the elements and combinations particularly pointed out in the appended claims.

It is to be understood that both the foregoing general description and the following detailed description are examples and explanatory only and are not restrictive of the disclosed embodiments as claimed.

### BRIEF DESCRIPTION OF THE DRAWINGS

The accompanying drawings constitute a part of this specification. The drawings illustrate several embodiments of the present disclosure, and together with the description, serve to explain the principles of the disclosed embodiments.

FIG. 1 depicts a bell portion of a fitting with a closed clamshell section, consistent with embodiments of the present disclosure.

FIG. 2A depicts a bell portion of a fitting with a partially opened clamshell section, consistent with embodiments of the present disclosure.

FIG. 2B depicts a bell portion of a fitting with a fully opened clamshell section, consistent with embodiments of the present disclosure.

FIG. 3 depicts an isometric view of a fitting with an enclosed bell and spigot connection, consistent with embodiments of the present disclosure.

FIG. 4 depicts a section cut of a fitting with an enclosed bell and spigot connection, consistent with embodiments of the present disclosure.

FIG. 5 depicts a front view of a fitting with an enclosed bell and spigot connection, consistent with embodiments of the present disclosure.

FIG. 6 depicts an isometric view of a fitting with a concentric bell connection, consistent with embodiments of the present disclosure

FIG. 7 depicts a section cut of a fitting with a concentric bell connection, consistent with embodiments of the present disclosure.

FIG. 8 depicts a front view of a fitting with a concentric bell connection, consistent with embodiments of the present disclosure.

FIG. 9 depicts an isometric view of a fitting with an eccentric bell connection, consistent with embodiments of the present disclosure.

FIG. 10 depicts a section cut of a fitting with an eccentric bell connection, consistent with embodiments of the present disclosure.

FIG. 11 depicts a front view of a fitting with an eccentric bell connection, consistent with embodiments of the present disclosure.

### DETAILED DESCRIPTION

Examples of embodiments of the present disclosure are described with reference to the accompanying drawings. In the figures, which are not necessarily drawn to scale, wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It should also be noted that as used in the present disclosure and in the appended claims, the singular forms “a,” “an,” and “the” include plural references unless the context clearly dictates otherwise.

The disclosed embodiments improve deficiencies in existing bell and spigot connections. The disclosed embodiments provide more secure connections between a bell portion of a pipe or fitting and spigot portion of a pipe or fitting. Further, the disclosed embodiments allow a bell portion to accommodate a wider range of dimensions of spigot portions.

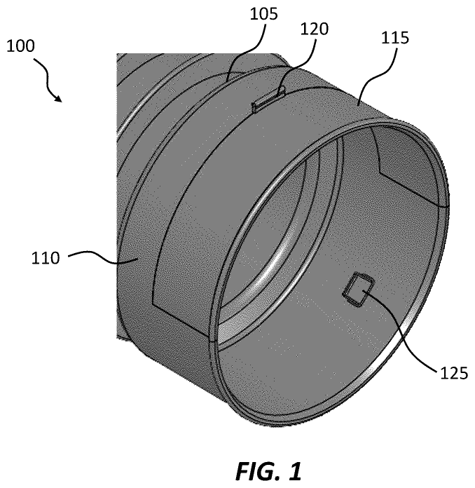

FIG. 1 depicts an isometric view of bell portion 110 of fitting 100. Fitting 100 may comprise a single wall, dual wall, or triple wall configuration and may have an external wall that is corrugated or smooth. In some embodiments, the internal wall of fitting 100 may be corrugated or smooth. Fitting 100 may be formed of various plastic materials, including polyvinyl chloride (PVC), polyethylene, polypropylene, or any other plastic materials. In some embodiments, fitting 100 may be formed of other non-plastic materials. In some embodiments, fitting 100 may include a T-shaped fitting, a cross fitting, a wye fitting, an elbow fitting, or any other fitting configured to connect two or more pipes or an end cap. Fitting 100 may include a hollow body 105 and bell portion 110. As depicted in FIG. 1, bell portion 110 of fitting 100 may have a wider diameter than hollow body 105 of fitting 100. The wider diameter of bell portion 110 may facilitate the connection of a spigot portion of a second pipe to bell portion 110. For example, a spigot portion (not depicted) may be inserted into bell portion 110 to facilitate the flow of water through hollow body 105 to the spigot portion.

Bell portion 110 of fitting 100 may include clamshell 115. Clamshell 115 may comprise a hinged opening in bell portion 110 of fitting 100. Clamshell 115 may open upwardly by hinge 120. Hinge 120 may include a living hinge. For example, a living hinge may comprise a flexible hinge made from the same material as clamshell 115 and bell portion 110 that are connected by the living hinge. For example, hinge 120 may be integral to clamshell 115. In some embodiments, as depicted in FIG. 1, clamshell 115 may extend only over a portion of the width of bell portion 110. In other embodiments, clamshell 115 may extend over the entire width of bell portion 110. Further, in some embodiments, as depicted in FIG. 1, clamshell 115 may extend around half of the circumference of bell portion 110. In other embodiments, clamshell 115 may extend around less than or more than half of the circumference of bell portion 110.

Bell portion 110 may further include at least one cleat 125. The at least one cleat 125 may extend upwardly from an internal surface of bell portion 110 of fitting 100. The at least one cleat 125 may facilitate a tight and secure connection between the internal surface of bell portion 110 and a spigot portion inserted into bell portion 110. In some embodiments, the at least one cleat 125 may include a rounded protrusion extending upwardly from the internal surface of bell portion 110, a wedge-shaped protrusion, or any other shaped protrusion from the internal surface of bell portion 110. Although FIG. 1 depicts one cleat 125, bell portion 110 may include any number of cleats 125. For example, in some embodiments, bell portion 110 may include three or four cleats 125 spaced equidistantly around the internal surface of bell portion 110. When a second pipe is installed within clamshell opening 115 of bell portion 110, the closed clamshell opening 115 and cleats 125 may create a soil tight connection between bell portion 110 and the second pipe.

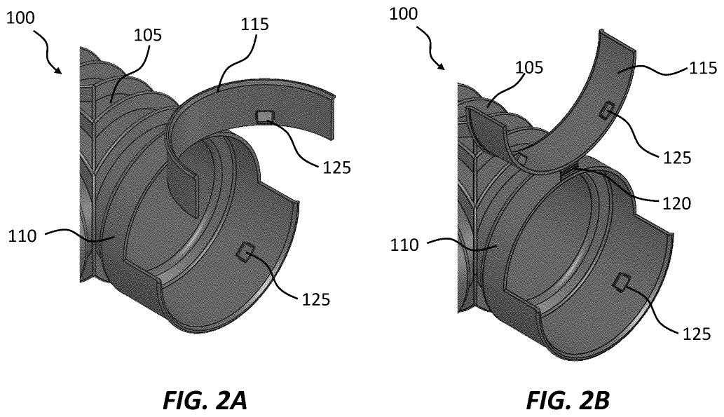

FIG. 2A depicts clamshell opening 115 in a partially open position and FIG. 2B depicts clamshell opening 115 in a fully open position. In some embodiments, hinge 120 (as depicted in FIG. 2B) may include a ratcheting hinge. For example, a ratcheting hinge may allow clamshell opening 115 to be locked into and held in specific positions, such as the partially open position of FIG. 2A and fully open position of FIG. 2B. In other embodiments, the ratcheting hinge may allow clamshell opening 115 to be opened and locked in other positions not depicted in FIG. 2A and FIG. 2B. As depicted in FIG. 2A and FIG. 2B, clamshell opening 115 may be opened to allow the spigot portion of a second pipe to be placed within bell portion 110 of fitting 100. Opening clamshell opening 115 into a partially open or fully open position may allow pipes with varying dimensions (such as pitch, outer diameter, inner diameter, etc.) to be fitted within bell portion 110. Opening clamshell opening 115 may allow for easier insertion and/or removal of a second pipe in bell portion 110. Further, closing clamshell opening 115 around the second pipe may improve engagement between cleats 125 and the second pipe installed within bell portion 110 to create a soil tight connection between bell portion 110 and the second pipe.

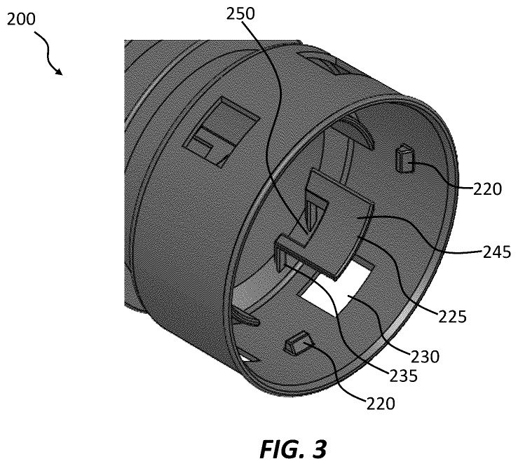

FIG. 3 depicts fitting 200 with an enclosed bell and spigot connection. Because fitting 200 includes an enclosed bell connection and spigot connection, as disclosed herein, fitting 200 may engage pipes of varying diameters. For example, the bell portion of fitting 200, as disclosed herein, may engage pipes with larger outer diameters. The spigot portion of fitting 200, as disclosed herein, may engage pipes with smaller outer diameters. By including an enclosed bell portion and spigot portion within fitting 200, fitting 200 may be connected with a range of second pipes of varying diameters. This may increase the flexibility and field adaptability of fitting 200. In some embodiments, fitting 200 may include a T-shaped fitting, a cross fitting, a wye fitting, an elbow fitting, or any other fitting configured to connect two or more pipes or an end cap.

Fitting 200 may include cleats 220 that may act as a bell portion to engage a second pipe with a larger outer diameter. For example, cleats 220 may engage a second pipe with an outer diameter that generally corresponds to the inner diameter of fitting 200. Cleats 220 may facilitate a tight and secure connection between the internal surface of fitting 200 and a spigot portion of a second pipe. In some embodiments, cleats 220 may include a rounded protrusion extending upwardly from the internal surface of fitting 200, a wedge-shaped protrusion, or any other shaped protrusion from the internal surface of fitting 200.

Fitting 200 may further include a plurality of internal spigot portions 225. Internal spigot portion 225 may be raised from the internal surface of fitting 200 by legs 235. For example, legs 235 may extend vertically from the internal surface of fitting 200, so that internal spigot portion 225 may be positioned to engage pipes with smaller diameters than fitting 200. Spigot surface 245 may extend from legs 235. As spigot surface 245 extends from legs 235, spigot surface 245 may include gap 250. Spigot surface 245 and gap 250 may engage with the bell portion of a second pipe inserted into fitting 200. For example, a second pipe with a bell portion including cleats may be inserted into fitting 200 and the cleats of the second pipe may engage with spigot surface 245 and/or gap 250 to provide a secure connection between internal spigot portion 225 of fitting 200 and the bell portion of the second pipe. The bell portion of the second pipe may include a diameter that may generally correspond to the diameter of the plurality of internal spigot portions 225. Therefore, internal spigot portion 225 may engage with a second pipe that has a diameter smaller than the diameter of fitting 200. In some embodiments, internal spigot portion 225 may be made from a same material as cleats 220. In other embodiments, internal spigot portion 225 may be made from a different material than cleats 220. The internal surface of fitting 200 may further include opening 230. Opening 230 may facilitate the manufacture and molding of fitting 200. For example, opening 230 may allow for the molding of internal spigot portions 225.

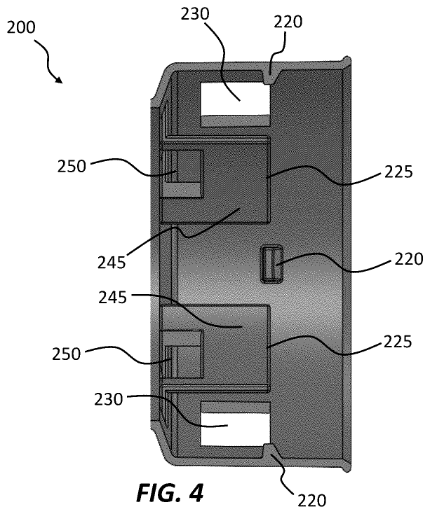

FIG. 4 depicts a section cut of fitting 200. As depicted in FIG. 4, opening 230 may be aligned with internal spigot portion 225. Cleats 220 may be spaced between opening 230 on the internal surface of fitting 200. Accordingly, cleats 220 may be aligned in between internal spigot portions 225 around the internal surface of fitting 200. As further depicted in FIG. 4, spigot portions 225 may include spigot surface 245 and gap 250. Spigot surface 245 and gap 250 may engage with the bell portion of a second pipe inserted into fitting 200. For example, a second pipe with a bell portion including cleats may be inserted into fitting 200 and the cleats of the second pipe may engage with spigot surface 245 and/or gap 250 to provide a secure connection between internal spigot portion 225 of fitting 200 and the bell portion of the second pipe.

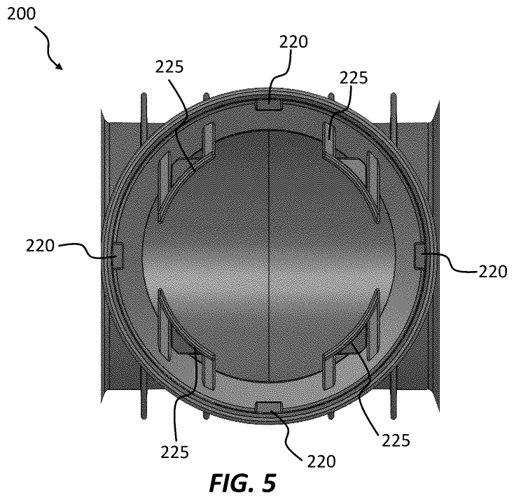

FIG. 5 depicts a front view of fitting 200. As depicted in FIG. 5, fitting 200 may include four cleats 220. Cleats 220 may be spaced equidistantly around the inner circumference of fitting 200. Spacing cleats 220 equidistantly around the inner circumference of fitting 200 may allow cleats 220 to center a second pipe that is inserted into fitting 200 within fitting 200. Centering a second pipe within fitting 200 may facilitate the flow of water from fitting 200 through the second pipe. Similarly, as depicted in FIG. 5, fitting 200 may include four internal spigot portions 225. Internal spigot portions 225 may be spaced equidistantly around the inner circumference of fitting 200 to center a second pipe inserted into fitting 200 within fitting 200. As depicted in FIG. 5, the surface of internal spigot portions 225 may include a curvature that corresponds to the curvature of the internal surface of fitting 200. The curvature of the surface of internal spigot portions 225 may improve engagement between internal spigot portions 225 and a second pipe to facilitate a tight and secure connection. Although FIG. 5 depicts four cleats 220 and four internal spigot portions 225, fitting 200 may include any number of cleats 220 and internal spigot portions 225.

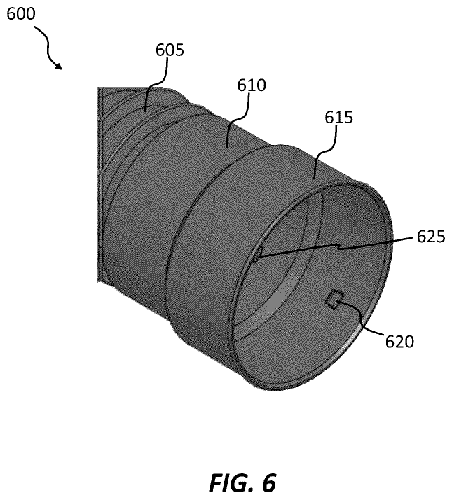

FIG. 6 depicts fitting 600 with concentric stepped bell portions. Fitting 600 may include hollow body 605, large bell portion 615, and small bell portion 610. As depicted in FIG. 1, a diameter of small bell portion 610 and large bell portion 615 may each be larger than a diameter of hollow body 605 of fitting 600. The wider diameters of small bell portion 610 and large bell portion 615 may facilitate the connection of a spigot portion of a pipe to fitting 600. For example, a spigot portion of a pipe (not depicted) may be inserted into small bell portion 610 or large bell portion 615 to facilitate the flow of water through body 605 to the spigot portion. In some embodiments, fitting 600 may include a T-shaped fitting, a cross fitting, a wye fitting, an elbow fitting, or any other fitting configured to connect two or more pipes or an end cap.

As depicted in FIG. 6, small bell portion 610 may be located between body 605 of fitting 600 and large bell portion 615. By locating small bell portion 610 between body 605 and large bell portion 615, small bell portion 610 may be utilized without cutting off large bell portion 615 from the end of fitting 600. A diameter of small bell portion 610 may be less than a diameter of large bell portion 615. Accordingly, large bell portion 615 may be configured to connect to spigot portions of pipes with larger outer diameters and small bell portion 610 may be configured to connect to spigot portions of pipes with smaller outer diameters. Small bell portion 610 and large bell portion 615 may provide increased field adaptability for fitting 600 by allowing fitting to connect to pipes of varying diameters.

As disclosed herein, small bell portion 610 may include at least one cleat 625 and large bell portion 615 may include at least one cleat 620. The at least one cleat 620 may extend upwardly from an internal surface of large bell portion 615 of fitting 600. The at least one cleat 625 may extend upwardly from an internal surface of small bell portion 610 of fitting 600. The at least one cleat 620 and 625 may facilitate a tight and secure connection between the internal surface of large bell portion 615 or small bell portion 610 and a spigot portion inserted large bell portion 615 or small bell portion 610. In some embodiments, the at least one cleat 620 or 625 may include a rounded protrusion extending upwardly from the internal surface of large bell portion 615 or small bell portion 610, a wedge-shaped protrusion, or any other shaped protrusion from the internal surface of large bell portion 615 or small bell portion 610.

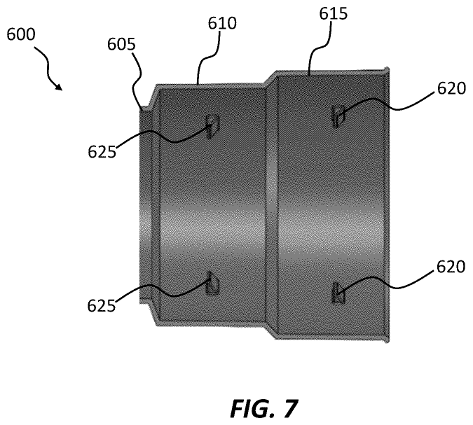

FIG. 7 depicts a section cut of fitting 600. As depicted in FIG. 7, small bell portion 610 and large bell portion 615 may be aligned concentrically. Aligning small bell portion 610 and large bell portion 615 concentrically may allow for the flow of water to remain centralized throughout the transfer of the flow of water between fitting 600 and a connected pipe. Small bell portion 610 and large bell portion 615 may further include a constant wall thickness. As further depicted in FIG. 7, small bell portion 610 may include cleats 625 and large bell portion 615 may include cleats 620. Cleats 625 of small bell portion 610 may facilitate a tight and secure connection between small bell portion 610 and a spigot portion of a pipe (not depicted). In some embodiments, the spigot portion of the pipe may have an outer diameter that may correspond to the inner diameter of small bell portion 610. Cleats 620 of large bell portion 615 may facilitate a tight and secure connection between large bell portion 615 and a spigot portion of a pipe (not depicted). In some embodiments, the spigot portion of the pipe may have an outer diameter that corresponds to the inner diameter of large bell portion 615. Accordingly, large bell portion 615 may facilitate the connection of fitting 600 to pipes of larger outer diameters and small bell portion 610 may facilitate the connection of fitting 600 to pipes of smaller outer diameters.

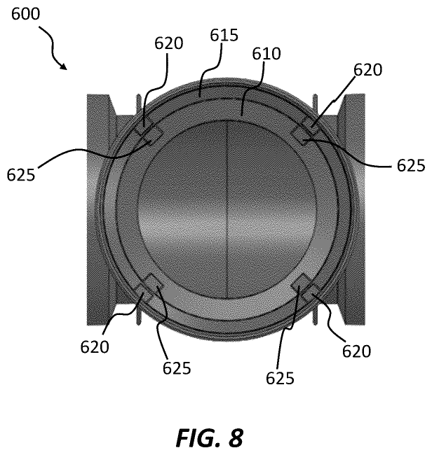

FIG. 8 depicts a front view of fitting 600. As depicted in FIG. 8, large bell portion 615 may include four cleats 620 and small bell portion 610 may include four cleats 625. Cleats 620 may be spaced equidistantly around the inner circumference of large bell portion 615 and cleats 625 may be spaced equidistantly around the inner circumference of small bell portion 610. Spacing cleats 620 and 625 equidistantly around the inner circumference of large bell portion 615 and small bell portion 610 may allow cleats 620 and 625 to center a second pipe that is inserted into fitting 600 within fitting 600. Centering a second pipe within fitting 600 may facilitate the flow of water from fitting 600 through the second pipe. Although FIG. 8 depicts four cleats 620 and four cleats 625, fitting 600 may include any number of cleats 620 and cleats 625.

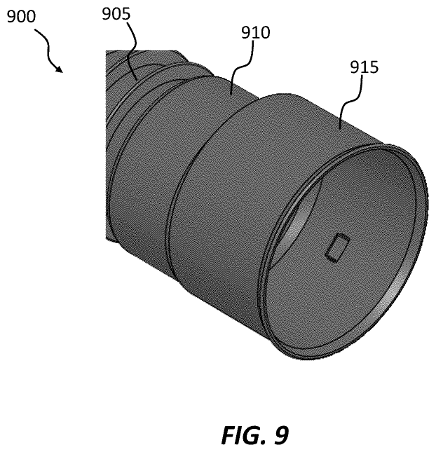

FIG. 9 depicts fitting 900 with eccentric stepped bell portions. Fitting 900 may include a hollow body 905, large bell portion 915, and small bell portion 910. As depicted in FIG. 9, a diameter of small bell portion 910 and large bell portion 915 may each be larger than a diameter of body 905 of fitting 900. The wider diameters of small bell portion 910 and large bell portion 915 may facilitate the connection of a spigot portion of a pipe to fitting 900. For example, a spigot portion of a pipe (not depicted) may be inserted into small bell portion 910 or large bell portion 915 to facilitate the flow of water through body 905 to the spigot portion. In some embodiments, fitting 900 may include a T-shaped fitting, a cross fitting, a wye fitting, an elbow fitting, or any other fitting configured to connect two or more pipes or an end cap.

As depicted in FIG. 9, small bell portion 910 may be located between body 905 of fitting 900 and large bell portion 915. By locating small bell portion 910 between body 905 and large bell portion 915, small bell portion 910 may be utilized without cutting off large bell portion 915 from the end of fitting 900. A diameter of small bell portion 910 may be less than a diameter of large bell portion 915. Accordingly, large bell portion 915 may be configured to connect to spigot portions of pipes with larger outer diameters and small bell portion 910 may be configured to connect to spigot portions of pipes with smaller outer diameters. Small bell portion 910 and large bell portion 915 may provide increased field adaptability for fitting 900 by allowing fitting 900 to connect to pipes of varying diameters.

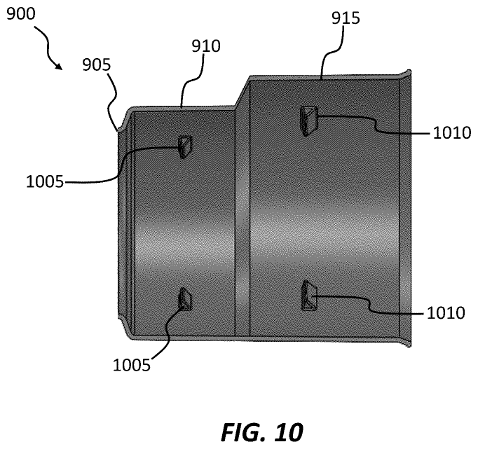

FIG. 10 depicts a section cut of fitting 900. As depicted in FIG. 9, small bell portion 910 and large bell portion 915 may be aligned eccentrically. Aligning small bell portion 910 and large bell portion 915 eccentrically may allow for gravity driven flow to remain at the same ground level through the transference of the flow of water between fitting 900 and a connected pipe. Small bell portion 910 and large bell portion 915 may further include a constant wall thickness.

As disclosed herein, small bell portion 910 may include at least one cleat 1005 and large bell portion 915 may include at least one cleat 1010. The at least one cleat 1010 may extend upwardly from an internal surface of large bell portion 915 of fitting 900. The at least one cleat 1005 may extend upwardly from an internal surface of small bell portion 910 of fitting 900. The at least one cleat 1005 and 1010 may facilitate a tight and secure connection between the internal surface of large bell portion 915 or small bell portion 910 and a spigot portion inserted into large bell portion 915 or small bell portion 910. In some embodiments, the at least one cleat 1005 or 1010 may include a rounded protrusion extending upwardly from the internal surface of large bell portion 915 or small bell portion 910, a wedge-shaped protrusion, or any other shaped protrusion from the internal surface of large bell portion 915 or small bell portion 910.

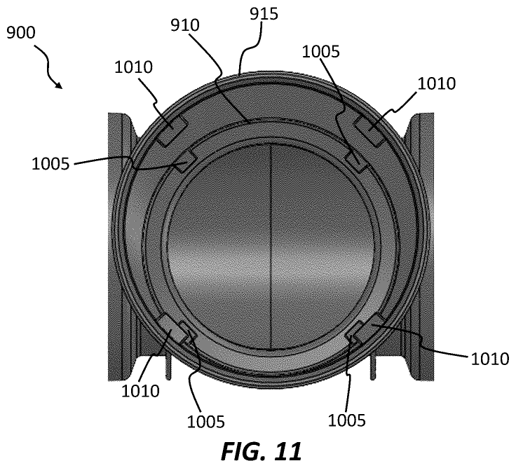

FIG. 11 depicts a front view of fitting 900. As depicted in FIG. 11, large bell portion 915 may include four cleats 1010 and small bell portion 910 may include four cleats 1005. Cleats 1010 may be spaced equidistantly around the inner circumference of large bell portion 915 and cleats 1005 may be spaced equidistantly around the inner circumference of small bell portion 910. Spacing cleats 1005 and 1010 equidistantly around the inner circumference of large bell portion 915 and small bell portion 910 may allow cleats 1005 and 1010 to center a second pipe that is inserted into fitting 900 within fitting 900. Centering a second pipe within fitting 900 may facilitate the flow of water from fitting 900 through the second pipe. Although FIG. 11 depicts four cleats 1005 and four cleats 1010, fitting 900 may include any number of cleats 1005 and cleats 1010. In some embodiments, not depicted in FIGS. 10 and 11, large bell portion 915 may include a clamshell opening, such as clamshell 115 as depicted herein with respect to FIG. 1. The clamshell may comprise a hinged opening in large bell portion 915. The clamshell opening may facilitate an easier installation of the spigot portion of a pipe into large bell portion 915.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and, accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A fitting, comprising:
a hollow body;
a bell portion extending from the body, wherein the bell portion comprises:
a clamshell opening; and
at least one cleat extending from an internal surface of the bell portion.

2. The fitting of claim 1, wherein the clamshell opening comprises a living hinge configured to open and close the clamshell opening.

3. The fitting of claim 1, wherein the clamshell opening is configured to open a portion of the bell portion to connect a pipe to the bell portion.

4. The fitting of claim 1, wherein the clamshell opening comprises a ratcheting hinge configured to lock the clamshell opening in an open position.

5. The fitting of claim 1, wherein a diameter of the bell portion is greater than a diameter of the hollow body.

6. The fitting of claim 1, wherein the clamshell opening extends around half a circumference of the end.

7. A fitting, comprising:
a hollow body;
an end extending from the body, wherein the end comprises:
an internal bell portion comprising at least one cleat extending from an internal surface of the end; and
a plurality of internal spigot portions comprising a spigot surface raised above the internal surface of the end by legs.

8. The fitting of claim 7, wherein the internal bell portion is configured to engage a pipe with an outer diameter that corresponds to an inner diameter of the end.

9. The fitting of claim 7, wherein the internal spigot portion is configured to engage a pipe with an inner diameter that corresponds to an outer diameter of the internal spigot portion.

10. The fitting of claim 7, wherein the at least one cleat comprises four cleats.

11. The fitting of claim 10, wherein the at least one cleat is spaced equidistantly around an inner circumference of the end.

12. The fitting of claim 7, wherein the plurality of internal spigot portions comprises four internal spigot portions.

13. The fitting of claim 12, wherein the plurality of internal spigot portions are spaced equidistantly around an inner circumference of the end.

14. The fitting of claim 7, wherein the internal bell portion is made from a same material as the internal spigot portion.

15. The fitting of claim 7, wherein the internal bell portion is made from a different material than the internal spigot portion.

16. A fitting, comprising:
a hollow body;
a small bell portion comprising at least one cleat extending upwardly from an internal surface of the small bell portion; and
a large bell portion comprising at least one cleat extending upwardly from an internal surface of the large bell portion;
wherein the small bell portion is located between the hollow body and the large bell portion.

17. The fitting of claim 16, wherein a diameter of the small bell portion is greater than a diameter of the hollow body and the diameter of the small bell portion is less than a diameter of the large bell portion.

18. The fitting of claim 16, wherein a diameter of the large bell portion is larger than a diameter of the hollow body and a diameter of the small bell portion.

19. The fitting of claim 16, wherein the large bell portion and the small bell portion are oriented concentrically.

20. The fitting of claim 16, wherein the large bell portion and the small bell portion are oriented eccentrically.
